(19) United States
(12) Patent Application Publication
(10) Pub. No.: US 2015/0073714 A1
(43) Pub. Date: Mar. 12, 2015

(54) VSP SYSTEMS AND METHODS REPRESENTING SURVEY DATA AS PARAMETERIZED COMPRESSION, SHEAR, AND DISPERSIVE WAVE FIELDS

(71) Applicant: Richard D. Foy, Denver, TX (US)

(72) Inventor: Richard D. Foy, Denver, TX (US)

(73) Assignee: LANDMARK GRAPHICS CORPORATION, Houston, TX (US)

(21) Appl. No.: 14/389,321

(22) PCT Filed: Apr. 2, 2012
(86) PCT No.: PCT/US12/31788

§ 371 Date: Sep. 29, 2014

(51) Int. Cl. G01V 1/40; G01V 1/34; G01V 1/28; G01V 1/16

(52) U.S. Cl. CPC G01V 1/40; G01V 1/16; G01V 1/345; G01V 1/284; G01V 1/282
USPC 702/14

(57) ABSTRACT

Disclosed vertical seismic profiling (VSP) survey systems and method acquire multi-component signal data and represent the signal data in terms of a combination of parameterized compression, shear, and dispersive wavefields. Multiples of each wavefield type may be included, e.g., to separate upgoing and downgoing wavefield components. A nonlinear optimization is employed to concurrently estimate an incidence angle and a slowness value for each wavefield. For the dispersive wavefield(s), the slowness may be parameterized in terms of a phase slowness and a group slowness with respect to a central wave frequency. The parameter values may vary as a function of depth.

### BACKGROUND

Vertical seismic profiling (VSP) surveys are useful for measuring the properties of geological formations surrounding a borehole. One technique for performing a VSP survey employs an array of seismic sensors positioned in an approximately-vertical borehole. A seismic source creates seismic waves at various shot locations on the surface. The sensors' responses to each shot are recorded and analyzed to extract the desired formation properties.

One formation property commonly measured in this manner is compressional wave velocity. We note here that compressional waves can also be termed compression waves, longitudinal waves, pressure waves, primary waves, or P-waves. Though the term “velocity” is commonly used, the measured value is normally a scalar value, i.e., the speed. This speed, or “velocity”, can also be equivalently expressed in terms of slowness, which is the reciprocal of speed. (In other words, the product of speed and slowness is unity.)

Other types of waves may also be generated, either by the seismic source itself, or by the interaction of the seismic wave energy with faults, formation interfaces, and solid-fluid interfaces (e.g., the earth's surface, the borehole). Such waves include shear waves and dispersive waves. Shear waves are often termed transverse waves, secondary waves, or S-waves. Dispersive waves are those waves whose frequency is not proportional to their wavenumber, i.e., different wavelengths propagate at different speeds. As not-necessarily distinct examples, dispersive waves include guided waves, interface waves, Lamb waves, Love waves, Q-waves, Rayleigh waves, Scholte waves, surface waves, Stoneley waves, and tube waves.

Generally speaking, compressional waves have higher velocities and higher amplitudes, making them easier to identify and measure particularly because they are the first wave type to reach the sensor array. However, shear modulus is a key formation property that can only be derived from shear wave velocity measurements. Unfortunately, dispersive waves and delayed compressional wave arrivals (e.g., delayed due to reflection and refraction) can obscure the shear waves as they reach the sensor array, making such measurements difficult and unreliable.

### BRIEF DESCRIPTION OF THE DRAWINGS

Accordingly, there are disclosed herein in the drawings and detailed description specific embodiments of vertical seismic profiling (VSP) survey systems that separate the survey data into compressional, shear, and dispersive wavefields. In the drawings:

FIG. 1 shows an illustrative VSP survey environment;

FIG. 2 shows an illustrative VSP survey system;

FIG. 3 shows illustrative seismic traces;

FIG. 4 is a flowchart of an illustrative VSP survey method;

FIG. 5 shows illustrative multi-component VSP survey data;

FIGS. 6-8 show illustrative compressional, shear, and dispersive wavefields, respectively;

FIGS. 9a-9c show extracted dispersive wavefield parameters;

FIG. 10 shows illustrative VSP data reconstructed from the wavefields; and

FIG. 11 shows illustrative residual noise components.

It should be understood, however, that the specific embodiments given in the drawings and detailed description do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

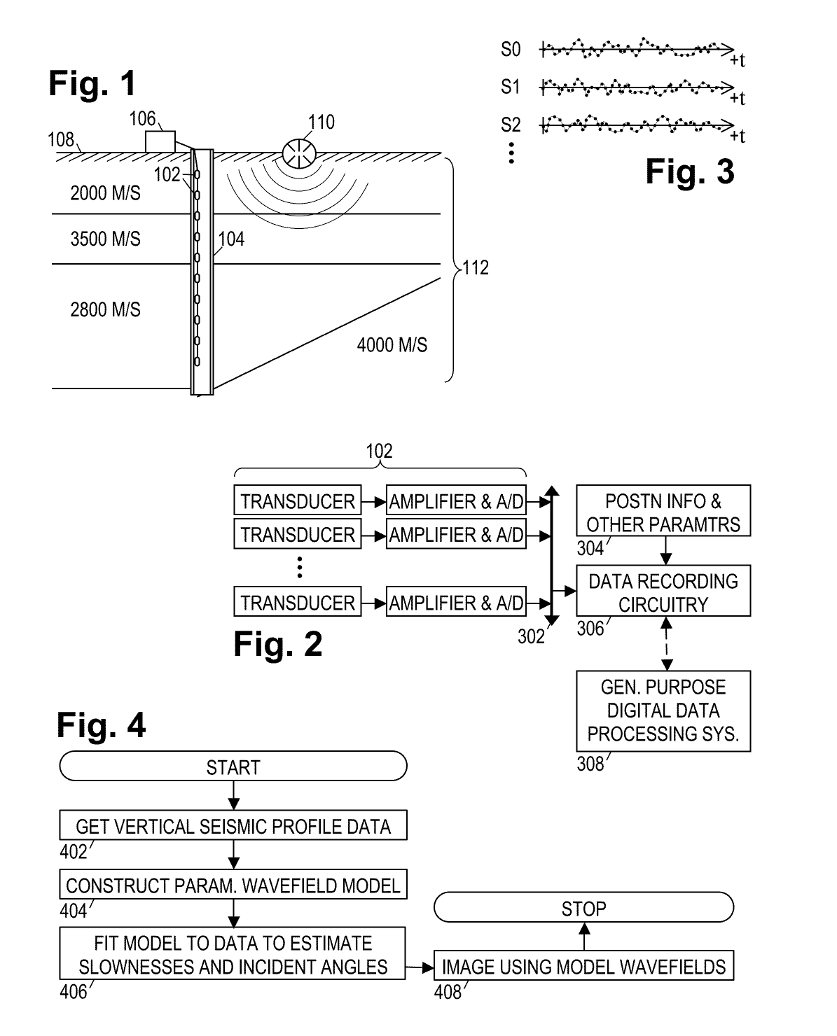

The disclosed systems and methods are best understood in an illustrative usage context. Accordingly, FIG. 1 shows an illustrative vertical seismic profiling (VSP) survey environment, in which surveyors position an array of seismic sensors 102 in a spaced-apart arrangement in a vertical borehole 104. For multi-component sensing, the sensors are clamped to the borehole wall or cemented in place. The sensors 102 communicate wirelessly or via cable to a data acquisition unit 106 that receives, processes, and stores the seismic signal data collected by the sensors. The surveyors trigger a seismic energy source 110 (e.g., a vibrator truck) at multiple positions (“shot locations”) on the earth's surface 108 to generate seismic energy waves that propagate through the earth 112. Such waves reflect from acoustic impedance discontinuities to reach the sensors 102. Illustrative discontinuities include faults, boundaries between formation beds, and fluid interfaces. The discontinuities may appear as bright spots in the subsurface structure representation that is derived from the seismic signal data.

FIG. 1 further shows an illustrative subsurface structure. In this figure, the earth has three relatively flat formation layers and a dipping formation layer of varying composition and hence varying speeds of sound. The formation pores may be filled with gas, water, or oil, which also affect the speed of sound through the formation.

FIG. 2 shows an illustrative VSP survey recording system having the sensors 102 coupled to a bus 302 to communicate digital signals to data recording circuitry 306. Position information for the sensors and other parameters useful for interpreting the recorded data can be detected with other sensors 304 and provided to the data recording circuitry 306 for storage. Illustratively, such additional information can include the precise locations of the sensors and source firings, source waveform characteristics, digitization settings, detected faults in the system, etc.

The seismic sensors 102 may each include multi-axis accelerometers and/or geophones and, in some environments, hydrophones, each of which may take high-resolution samples (e.g., 16 to 32 bits) at a programmable sampling rate (e.g., 400 Hz to 1 kHz). Recording circuitry 306 stores the data streams from sensors 102 onto a nonvolatile storage medium such as a storage array of optical or magnetic disks. The data is stored in the form of (possibly compressed) seismic traces, each trace being the signal detected and sampled by a given sensor in response to a given shot. (The shot and sensor positions for each trace are also stored and associated with the trace.)

A general purpose data processing system 308 receives the acquired VSP survey data from the data recording circuitry 306. In some cases the general purpose data processing system 308 is physically coupled to the data recording circuitry and provides a way to configure the recording circuitry and perform preliminary processing in the field. More typically, however, the general purpose data processing system is located at a central computing facility with adequate computing resources for intensive processing. The survey data can be transported to the central facility on physical media or communicated via a computer network. Processing system 308 includes a user interface having a graphical display and a keyboard or other method of accepting user input, enabling users to view and analyze the images and other information derived from the VSP survey data.

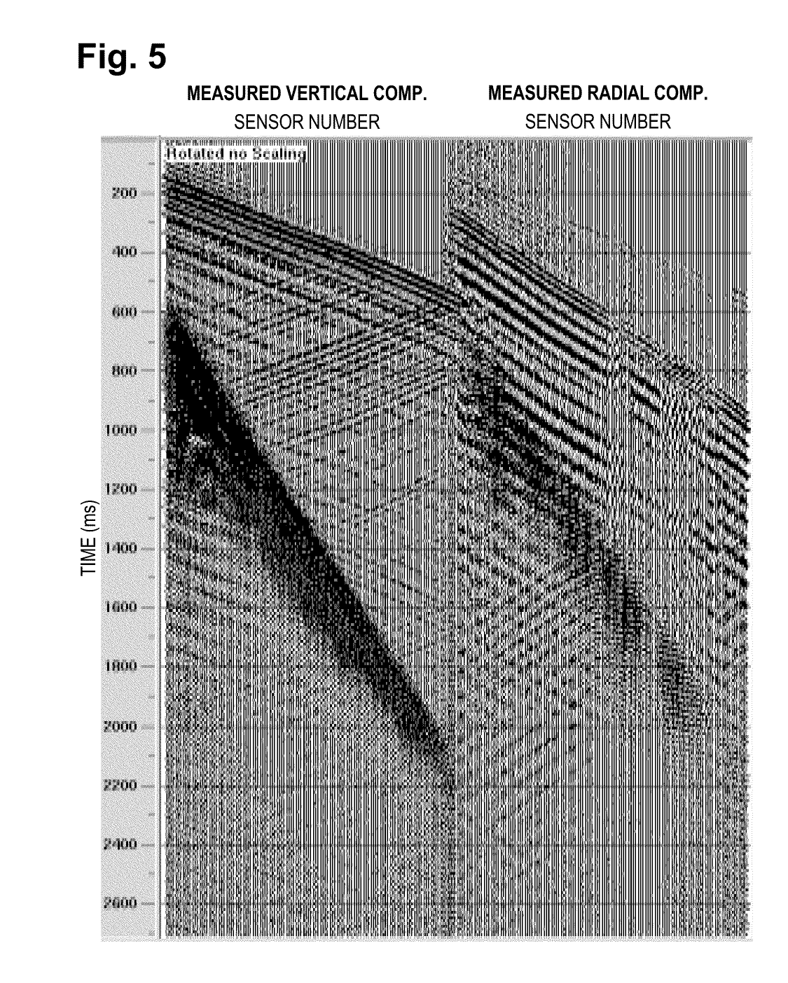

FIG. 3 shows illustrative seismic signals that might be recorded by the system of FIG. 2. The signals indicate some measure of seismic wave energy as a function of time (e.g., displacement, velocity, acceleration, pressure). We note, however, that there are normally dozens if not hundreds of traces, so it is usually infeasible to show the set of traces associated with any given shot in the separate, isolated manner of FIG. 3. Rather, the signals are typically shown in a “waterfall” format such as that seen in FIG. 5, where each signal is given a small offset from the signals associated with neighboring sensors, but they are otherwise shown with curves that are allowed to overlap each other. The overlapping lines create patterns that reveal trends in the data such as, e.g., the sloping lines indicating the arrival of seismic waves at the sensor array.

FIG. 4 is a flowchart of a VSP survey method that may be implemented by the system of FIG. 2. In block 402, the system obtains the VSP survey data as outlined above. In block 404, the system constructs a parameterized wavefield model having parameters for at least compressional waves, shear waves, and dispersive waves. The structure of this model is set forth in detail below. In block 406, the system fits the model to the data, using a nonlinear optimization method to determine the parameters that provide the best fit. In at least some embodiments, the system employs the Levenberg-Marquardt algorithm to achieve a best fit, but other optimization methods are known and may be employed, including Gauss-Newton, gradient descent, simulated annealing, and particle swarm optimization. The parameters determined for each wavefield are expected to include slowness and angle of incidence onto the sensor array.

In many cases, the wavefield slowness values may provide sufficient information to derive logs of the desired formation properties (e.g., shear modulus as a function of depth). In other cases, the parameterized model wavefields are used for further processing, as their noise content is sharply reduced relative to the acquired data. Thus the flowchart in FIG. 4 includes a block 408, in which the system derives a subsurface image from the parameterized model wavefields. The fundamentals of seismic imaging are well-known and accessible in various textbooks including Jon F. Claerbout, Imaging the Earth's Interior, Blackwell Scientific Publications, Oxford, 1985. The derived images, logs, or other representations of derived formation properties are displayed by the system as the VSP method reaches completion.

Turning now to the model, we represent the incidence angles of the P-wavefield, S-wavefield, and dispersive wavefield, respectively, as θₚ, θₛ, and θ_{disp}. These incidence angles cause the seismic energy to be distributed across the vertical and radial signal components in accordance with the polarization vectors dₚ, dₛ, and d_{disp}:

$${d}_{p} = [ \begin{matrix}- sin ( {θ}_{p} ) \\ cos ( {θ}_{p} )\end{matrix} ]$$

$${d}_{s} = [ \begin{matrix}cos ( {θ}_{s} ) \\ sin ( {θ}_{s} )\end{matrix} ]$$

$${d}_{disp} = [ \begin{matrix}- sin ( {θ}_{disp} ) \\ cos ( {θ}_{disp} )\end{matrix} ] .$$

Thus, if the wavefields have the frequency domain waveforms of wₚ(ω), wₛ(ω), and w_{disp}(ω), the two-component displacements at (reference) sensor 0 can be written

u₀(ω)=dₚwₚ(ω)+dₛwₛ(ω)+d_{disp}w_{disp}(ω).

The measurements at adjacent sensors are related by the frequency-domain time-shift operators for the P-wavefield, S-wavefield, and dispersive wavefield, respectively:

$${λ}_{p} = {e}^{i ω {q}_{p} Δ z}$$

$${λ}_{s} = {e}^{i ω {q}_{s} Δ z}$$

$${λ}_{disp} = {e}^{i ( {ω}_{0} {q}_{phase} + ( ω - {ω}_{0} ) {q}_{group} ) Δ z} ,$$

where Δ_{z} is the distance between adjacent sensors, qₚ and qₛ are the slownesses (inverse speed) of the P-wavefield and S-wavefield, qₚₕₐₛₑ and q_{group} are the phase and group slownesses of the dispersive wavefield, and ω₀ is a central wave frequency of the dispersive wavefield. For a four-sensor array, the model equations would be:

$$\{ \begin{matrix}{u}_{0} ( ω ) \\ {u}_{1} ( ω ) \\ {u}_{2} ( ω ) \\ {u}_{3} ( ω )\end{matrix} ] = \{ \begin{matrix}{d}_{p} {λ}_{p}^{0} & {d}_{s} {λ}_{s}^{0} & {d}_{disp} {λ}_{disp}^{0} \\ {d}_{p} {λ}_{p}^{1} & {d}_{s} {λ}_{s}^{1} & {d}_{disp} {λ}_{disp}^{1} \\ {d}_{p} {λ}_{p}^{2} & {d}_{s} {λ}_{s}^{2} & {d}_{disp} {λ}_{disp}^{2} \\ {d}_{p} {λ}_{p}^{3} & {d}_{s} {λ}_{s}^{3} & {d}_{disp} {λ}_{disp}^{3}\end{matrix} \} \{ \begin{matrix}{w}_{p} ( ω ) \\ {w}_{s} ( ω ) \\ {w}_{disp} ( ω )\end{matrix} \} .$$

Of course, more sensors (and sensor equations) can be added. In generalized form the equations can be expressed:

u(ω)=G(ω)w(ω)

where u(ω) is the measured sensor data, w(ω) is the wavefield vector, and G(ω) is the parameterized model. The eight parameters to be determined are θₚ, qₚ, θₛ, θ_{disp}, ω₀, qₚₕₐₛₑ, and q_{group}. Given an estimated set of parameters, the corresponding wavefield estimate is found by the least squares solution:

ŵ(ω)=(G^{T}G)⁻¹G^{T}u(ω),

and the error between the observed and modeled data is:

E=Σ_{ω}∥G(ω)w(ω)−u(ω)∥²

The nonlinear optimization algorithm seeks to find the parameter values that minimize this error. A sliding window approach may be employed, with signals from, e.g., 9 adjacent sensors being analyzed at a time. In addition to making the computation less demanding, this approach enables the parameter values to change with position to accommodate potential wavefield variations with depth.

We further note that the wavefield vector can be expanded to provide for multiple wavefields of each type. Thus, for example, the equations might provide for an upgoing P-wavefield, a downgoing P-wavefield, an upgoing S-wavefield, a downgoing S-wavefield, and a downgoing dispersive wavefield. A greater or lesser number of wavefields might be chosen based on the experience and intuition of the user.

FIGS. 5-11 provide an illustrative use of the disclosed systems and methods. FIG. 5 shows the geophone-measured VSP survey signals in terms of vertical and radial displacements. The sloping lines indicative of downgoing and upgoing wave fronts are apparent in both components, though the different wave fronts overlap and create interference patterns that make their interpretation more difficult.

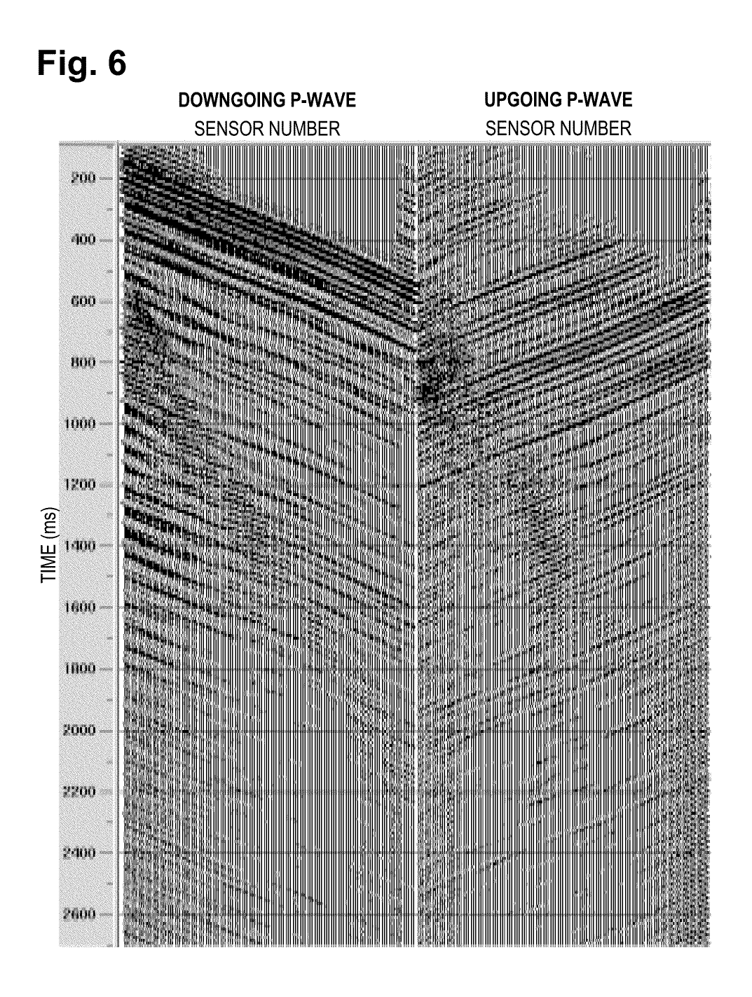

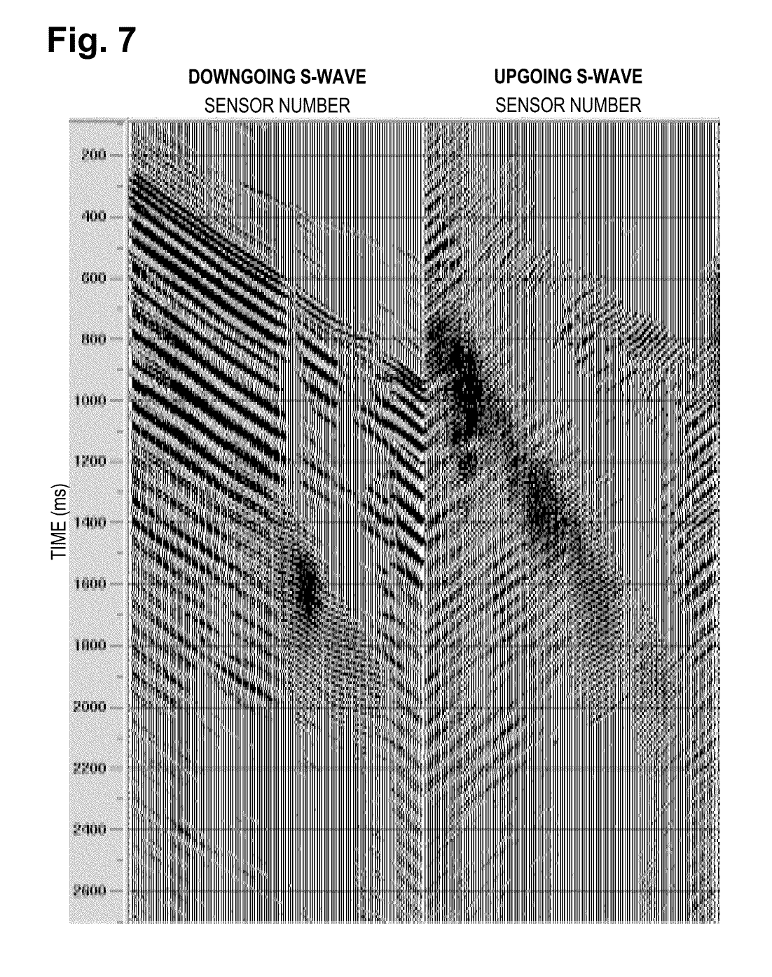

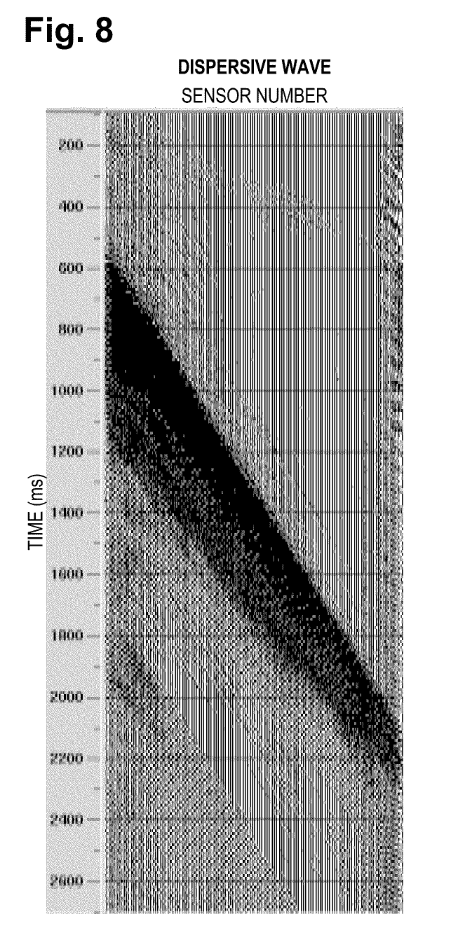

FIGS. 6-8 show the wavefields extracted from the data of FIG. 5 using the foregoing method. FIG. 6 shows the downgoing and upgoing P-wavefields. FIG. 7 shows the downgoing and upgoing S-wavefields. FIG. 8 shows the dispersive wavefield. It can be observed that substantially less interference exists between wavefields.

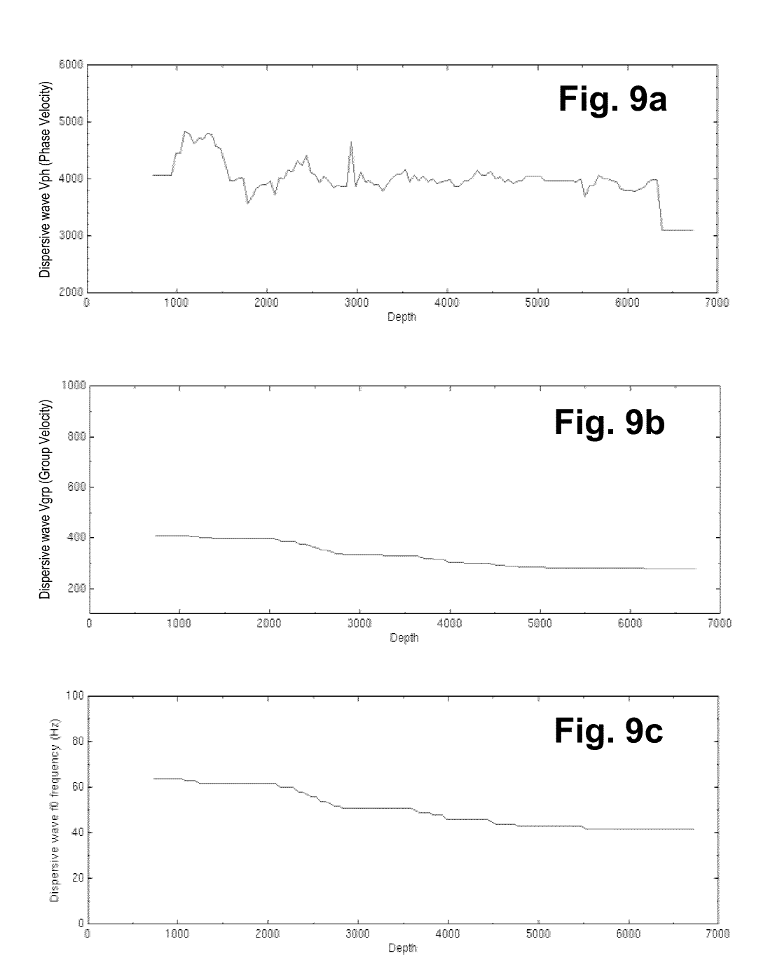

FIGS. 9a-9c show the extracted parameter values for the dispersive wavefield of FIG. 8. FIG. 9a shows the phase velocity as a function of depth. FIG. 9b shows the group velocity as a function of depth. FIG. 9c shows the central wave frequency as a function of depth. A gradual decrease of group velocity and central frequency can be observed with depth. The phase velocity exhibits a substantial amount of variation but otherwise does not seem to have a systematic dependence on depth.

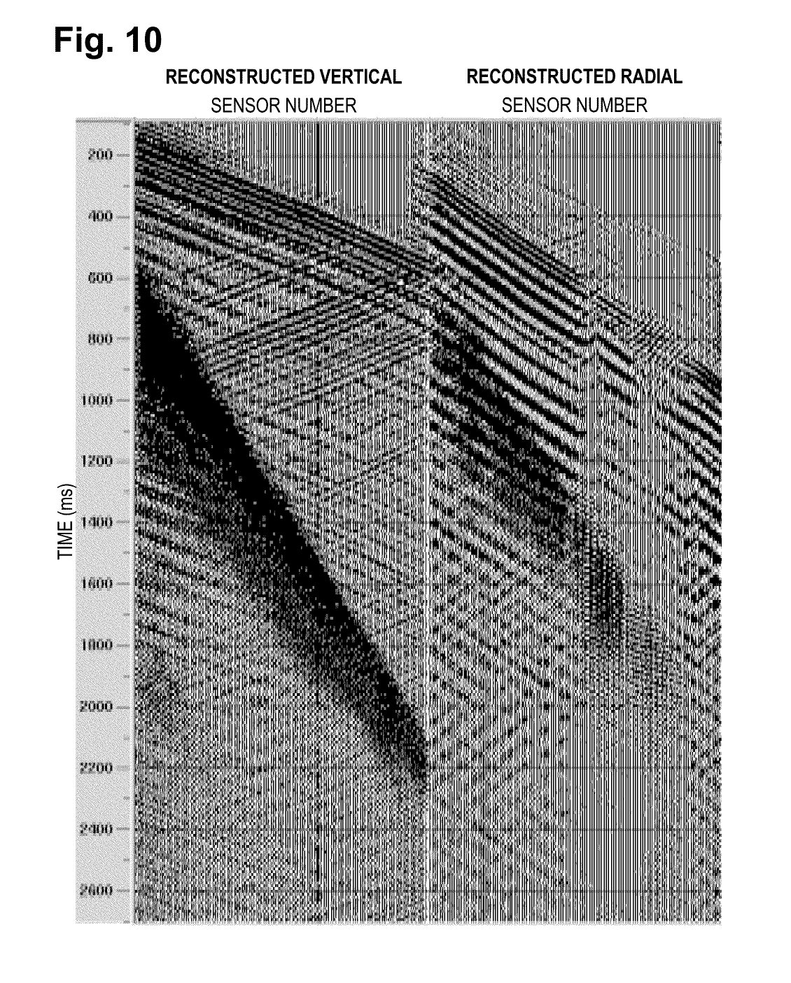

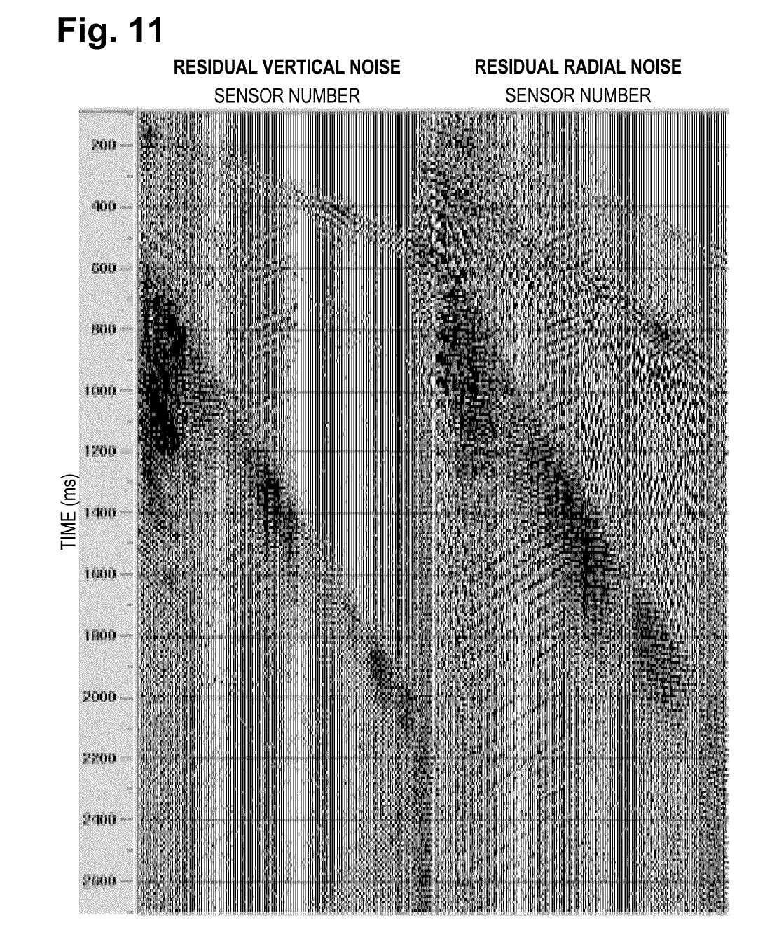

FIG. 10 shows a reconstruction of the vertical and radial signal components derived by summing the wavefields of FIGS. 6-8. As expected, there is a strong resemblance to the original data of FIG. 5. FIG. 11 shows the vertical and radial noise component obtained by subtracting the reconstructed signals of FIG. 10 from the original data of FIG. 5. A faint residue of the strongest wavefield components (the downgoing P-wave and the dispersive wave) can be seen, attributable to un-modeled nonlinearities.

Numerous variations and modifications will become apparent to those skilled in the art once the above disclosure is fully appreciated. It is intended that the following claims be interpreted to embrace all such variations and modifications.

What is claimed is:

1. A vertical seismic survey method that comprises:
receiving multi-component signal data from an array of sensors in a borehole;
constructing a parameterized wave field model that includes at least one compression wavefield, at least one shear wavefield, and at least one dispersive wavefield;
applying a nonlinear optimization to fit the model to the multi-component signal data, wherein the optimization concurrently estimates an incidence angle for each wave field and a slowness for each wave field; and
deriving a subsurface image from one or more of the optimized model's wave fields.

2. The method of claim 1, wherein the slowness for the dispersive wave field is estimated as a combination of phase slowness and group slowness with respect to a central wave frequency.

3. The method of claim 1, wherein the incidence angle and slowness for each wavefield varies with respect to depth.

4. The method of claim 1, further comprising clamping each of the sensors against a wall of the borehole before said receiving.

5. The method of claim 1, wherein the multi-component signal data includes a vertical displacement and a radial displacement.

6. The method of claim 1, further comprising:
initiating shots on a surface, wherein said receiving is performed in response to said initiating.

7. The method of claim 1, wherein the optimized model's wave fields include an upward-going compression wave field, a downward-going compression wave field, an upward-going shear wave field, a downward-going shear wave field, and a dispersive wave field.

8. A vertical seismic survey system that comprises:
an array of multicomponent sensors in a borehole;
a data acquisition system that records multi-component signal data from the array; and
a processing system that fits a parameterized wave field model to the multi-component signal data using a concurrent determination of an incidence angle for each wave field and a slowness for each wave field, the wave fields including at least one compression wave field, at least one shear wave field, and at least one dispersive wave field.

9. The system of claim 8, wherein the processing system further derives a subsurface image from one or more of said wave fields and displays said image to a user.

10. The system of claim 8, wherein the slowness for the dispersive wave field is estimated as a combination of phase slowness and group slowness with respect to a central wave frequency.

11. The system of claim 8, wherein the incidence angle and slowness for each wavefield varies with respect to depth.

12. The system of claim 8, wherein the sensors are clamped to a wall of the borehole or cemented in place.

13. The system of claim 12, wherein the multi-component signal data includes a vertical displacement and a radial displacement.

14. The system of claim 8, further comprising a seismic source that provides shots at one or more locations on a surface above the borehole.

15. The system of claim 8, wherein the processing system concurrently determines incidence angle and slowness for an upward-going compression wave field, a downward-going compression wave field, an upward-going shear wave field, a downward-going shear wave field, and a dispersive wave field.

16. An information storage medium that, when employed in operable relation with a processing system, configures the processing system with software that causes the processing system to:
obtain multi-component signal data recorded from an array of sensors in a borehole;
construct a parameterized wave field model that includes at least one compression wavefield, at least one shear wavefield, and at least one dispersive wavefield;
apply a nonlinear optimization to fit the model to the multi-component signal data, wherein the optimization concurrently estimates an incidence angle for each wave field and a slowness for each wave field.

17. The medium of claim 16, wherein the slowness for the dispersive wave field is estimated as a combination of phase slowness and group slowness with respect to a central wave frequency.

18. The medium of claim 16, wherein the incidence angle and slowness for each wavefield varies with respect to depth.

19. The medium of claim 16, wherein the multi-component signal data includes a vertical displacement and a radial displacement.

20. The medium of claim 16, wherein the optimized model's wave fields include an upward-going compression wave field, a downward-going compression wave field, an upward-going shear wave field, a downward-going shear wave field, and a dispersive wave field.
